(19) United States
(12) Patent Application Publication
(10) Pub. No.: US 2005/0230948 A1
(43) Pub. Date: Oct. 20, 2005

(54) Inflator with weld spatter collection

(75) Inventors: Ahmad K. Al-Amin, Slough (GB); Fred J. Cook, Gilbert, AZ (US); Waldemar K. Gremplewski, Mesa, AZ (US); Vincent J. Mramor, Chandler, AZ (US); Lloyd G. Green, Mesa, AZ (US)

Correspondence Address: TAROLLI, SUNDHEIM, COVELL & TUMMINO L.L.P., 1111 LEADER BLDG, 526 SUPERIOR AVENUE, CLEVELAND, OH, 44114-1400, US

(73) Assignee: TRW Vehicle Safety Systems Inc.

(21) Appl. No.: 10/827,870

(22) Filed: Apr. 20, 2004

(51) Int. Cl. B60R 21/26

(52) U.S. Cl. 280/736

(57) ABSTRACT

An apparatus (10) for helping to protect an occupant of a vehicle (12) includes an inflatable vehicle occupant protection device (14). An inflator (24) provides inflation fluid for inflating the protection device (14). A conduit (360) delivers the inflation fluid from the inflator (24) to the protection device (14). The inflator (24) includes an outlet passage (302) and a conduit receiving portion (300) for receiving an end portion (364) of the conduit (360). The conduit receiving portion (300) includes a wall portion (320, 330) that encircles the outlet passage (302) and is spaced from the end portion (364) of the conduit (360) to help define an annular space (372, 374) between the wall portion and the end portion.

### FIELD OF THE INVENTION

The present invention relates to an inflator that provides inflation fluid for inflating an inflatable vehicle occupant protection device.

### BACKGROUND OF THE INVENTION

It is known to inflate an inflatable vehicle occupant protection device to help protect a vehicle occupant in the event of a vehicle collision. One particular type of inflatable vehicle occupant protection device is an inflatable curtain that inflates from the roof of the vehicle downward inside the passenger compartment between a vehicle occupant and the side structure of the vehicle in the event of a side impact or rollover. A known inflatable curtain is inflated from a deflated condition by inflation fluid directed from an inflator to the inflatable curtain through a fill tube.

Another type of inflatable vehicle occupant protection device is a front air bag inflatable by inflation fluid directed into the air bag from an inflator. A driver side front air bag is inflated from a stored position in a vehicle steering wheel to a deployed position between an occupant of a front driver side seat and the steering wheel/instrument panel of the vehicle. A passenger side front air bag is inflated from a stored position in the instrument panel to a deployed position between an occupant of a front passenger side seat and the instrument panel.

Another type of inflatable vehicle occupant protection device is a side impact air bag inflatable between the side structure of the vehicle and a vehicle occupant. Side impact air bags may be stored in a variety of locations in the vehicle, such as the side structure, seat, door, or floor of the vehicle. A side impact air bag may be inflated by inflation fluid directed into the air bag from an inflator. Other types of inflatable vehicle occupant protection devices include inflatable seat belts and inflatable knee bolsters.

### SUMMARY OF THE INVENTION

The present invention relates to an apparatus for helping to protect an occupant of a vehicle. The apparatus includes an inflatable vehicle occupant protection device and an inflator that provides inflation fluid for inflating the protection device. A conduit delivers the inflation fluid from the inflator to the protection device. The inflator includes an outlet passage and a conduit receiving portion for receiving an end portion of the conduit. The conduit receiving portion includes a wall portion that encircles the outlet passage and is spaced from the end portion of the conduit to help define an annular space between the wall portion and the end portion.

The present invention also relates to an apparatus for providing inflation fluid to an inflatable vehicle occupant protection device. The apparatus includes an inflator actuatable to provide inflation fluid for inflating the inflatable vehicle occupant protection device. The inflator includes an outlet passage for discharging inflation fluid from the inflator. The apparatus also includes a conduit having an end portion welded to the inflator and encircling the outlet passage. An inner channel is formed inside the conduit adjacent the end portion of the conduit and encircles the outlet passage.

The present invention also relates to an apparatus for providing inflation fluid to an inflatable vehicle occupant protection device. The apparatus includes an inflator actuatable to provide inflation fluid for inflating the inflatable vehicle occupant protection device. The inflator includes an outlet passage for discharging inflation fluid from the inflator. The apparatus also includes a conduit having an end portion welded to the inflator and encircling the outlet passage. An outer channel is formed outside the conduit adjacent the end portion of the conduit and encircles the outlet passage.

The present invention also relates to an apparatus that includes an inflator actuatable to provide inflation fluid for inflating an inflatable vehicle occupant protection device. The apparatus also includes a conduit that delivers inflation fluid to the inflatable vehicle occupant protection device and a weld for securing the conduit to the inflator. The apparatus further includes means for collecting weld spatter generated during the formation of the weld.

The present invention also relates to an inflator for providing inflation fluid to an inflatable vehicle occupant protection device via a conduit. The inflator includes a structure defining a chamber for storing inflation fluid under pressure and a closure member rupturable to release inflation fluid from the chamber. The inflator also includes an end cap connectable with the structure. The end cap is connectable with the conduit via a weld. The end cap includes an annular channel located inside the conduit for collecting weld spatter resulting from the weld.

The present invention further relates to an inflator for providing inflation fluid to an inflatable vehicle occupant protection device via a conduit. The inflator includes a structure defining a chamber for storing inflation fluid under pressure and a closure member rupturable to release inflation fluid from the chamber. The inflator also includes an end cap connectable with the structure. The end cap is connectable with the conduit via a weld. The end cap includes an annular channel located outside the conduit for collecting weld spatter resulting from the weld.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic side view illustrating an apparatus for helping to protect an occupant of a vehicle, according to a first embodiment of the present invention;

FIG. 2 is a sectional view of an inflator portion of the apparatus of FIG. 1 in a non-actuated condition;

FIG. 3 is a sectional view of the inflator of FIG. 2 in an actuated condition;

FIG. 4 is a magnified sectional view of a portion of the inflator of FIG. 2;

FIG. 5 is an exploded view, partially in section, of the portion of the inflator of FIG. 4;

FIGS. 6A and 6B are sectional views illustrating the assembly of a portion of the inflator of FIG. 5; and

FIG. 7 is a sectional view illustrating an apparatus for helping to protect an occupant of a vehicle, according to a second embodiment of the present invention.

### DESCRIPTION OF EMBODIMENTS

The present invention relates to an apparatus for helping to protect an occupant of a vehicle. In particular, the present invention relates to an inflator for providing inflation fluid for inflating an inflatable vehicle occupant protection device, such as an inflatable curtain or air bag. Representative of the present invention, FIG. 1 illustrates an apparatus 10 for helping to protect an occupant (not shown) of a vehicle 12 in accordance with a first embodiment of the invention.

In the embodiment illustrated in FIG. 1, the apparatus 10 comprises an inflatable vehicle occupant protection device 14 in the form of an inflatable curtain. The protection device 14 may have a variety of alternative configurations (not shown), such as an inflatable front impact air bag (driver side or passenger side), a side impact air bag (side structure, door, seat, or floor mounted), an inflatable knee bolster, or an inflatable seat belt.

The inflatable curtain 14 is mounted adjacent the side structure 16 of the vehicle 12 and the roof 18 of the vehicle. An inflator 24 is connected in fluid communication with the inflatable curtain 14 through a fill tube 22. The fill tube 22 is of a metal material, such as steel. The fill tube 22 has a first end portion 26 for receiving fluid from the inflator 24. The fill tube 22 has a second end portion 28 disposed in the inflatable curtain 14. The second end portion 28 of the fill tube 22 may extend along the length of the inflatable curtain 14 to help distribute inflation fluid along the length of the curtain.

The vehicle 12 includes a sensor mechanism 30 (shown schematically in FIG. 1) for sensing the occurrence of an event for which inflation of the inflatable curtain 14 is desired, such as a side impact to the vehicle 12 and/or a vehicle rollover. Upon sensing the occurrence of such an event, the sensor mechanism 30 provides an electrical signal over lead wires 32 to the inflator 24. In response to the signal from the sensor 30, the inflator 24 is actuated and discharges inflation fluid into fill tube 22, which directs the fluid into the inflatable curtain 14.

The inflatable curtain 14 inflates under the pressure of the inflation fluid from the inflator 24. The inflatable curtain 14 inflates away from the roof 18 in a downward direction as shown in FIG. 1 and in a downward direction with respect to the direction of forward travel of the vehicle 12 to the position illustrated in FIG. 1. The inflatable curtain 14, when inflated, extends along the side structure 16 of the vehicle 12 and is positioned between the side structure and occupant(s) of the vehicle. The inflatable curtain 14, when inflated, helps to absorb the energy of impacts with the curtain and helps to distribute the impact energy over a large area of the curtain.

The inflator 24 contains a stored quantity of pressurized inflation fluid (not shown) in the form of a gas for inflating the inflatable curtain 14. The inflator 24 alternatively could contain a combination of pressurized inflation fluid and ignitable material for heating the inflation fluid, or could be a pyrotechnic inflator that uses the combustion of gas-generating material to generate inflation fluid. As a further alternative, the inflator 24 could be of any suitable type for supplying a medium for inflating the inflatable curtain 14.

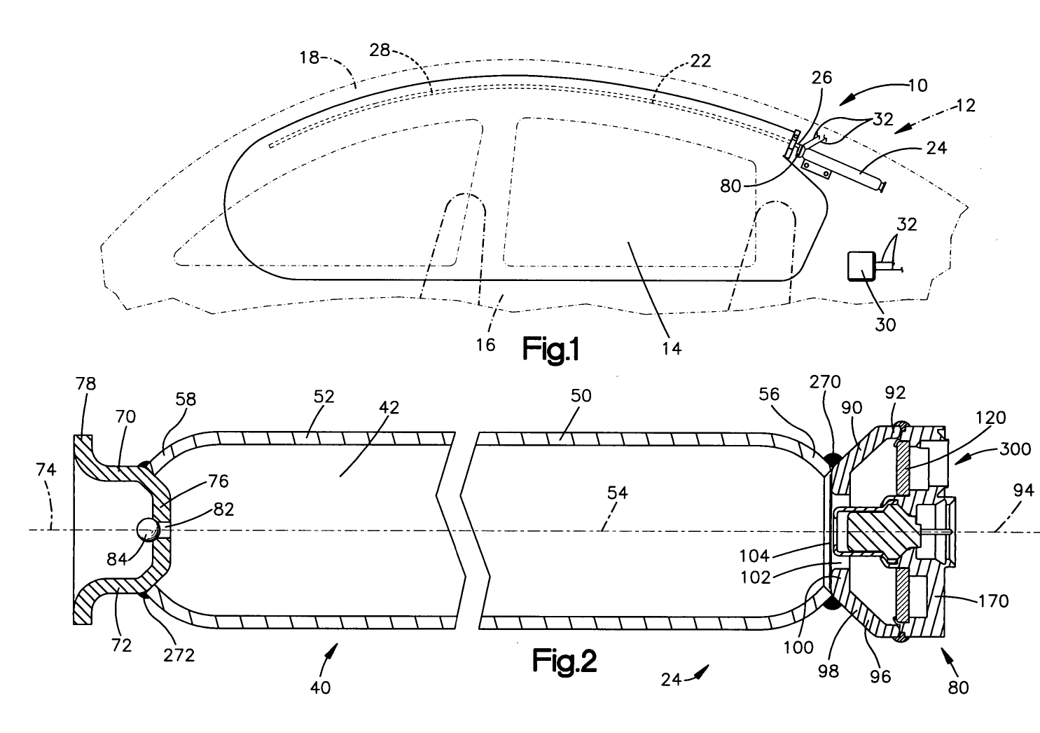

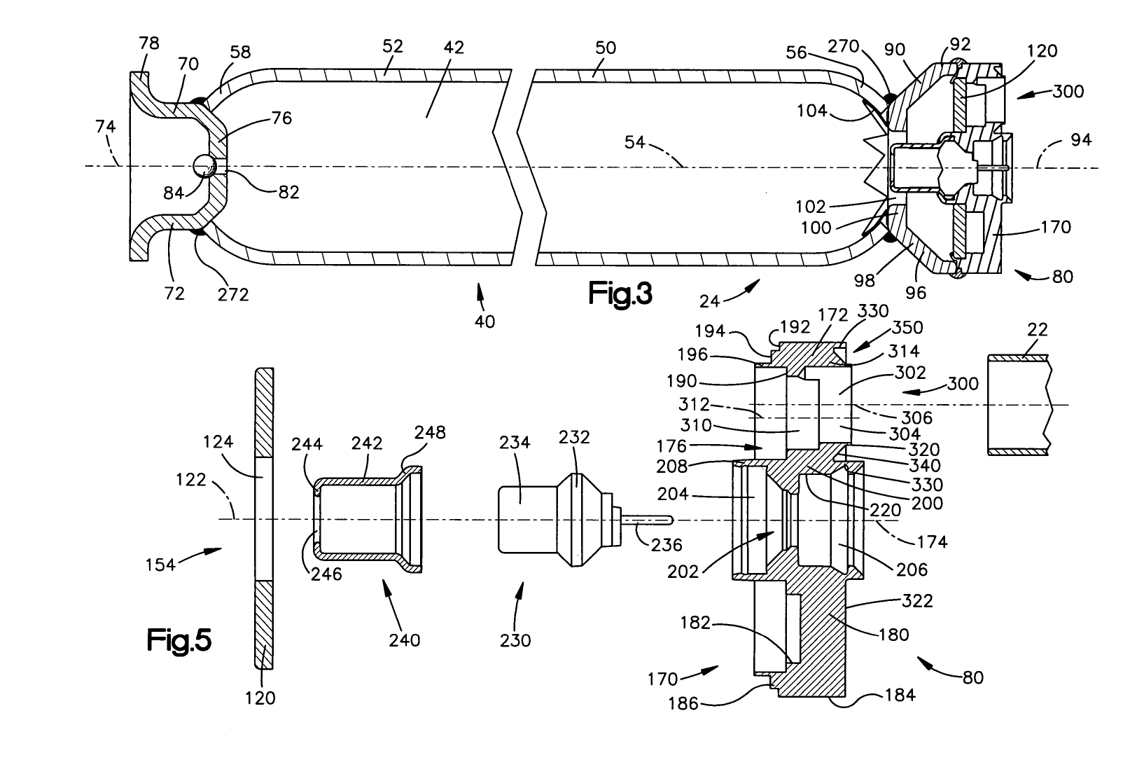

Referring to FIGS. 2 and 3, the inflator 24 includes a structure 40 that defines a chamber 42 from which inflation fluid flows when the inflator is actuated. In the embodiment illustrated in FIGS. 2 and 3, the inflator 24 is a stored gas inflator in which a pressurized gas, such as helium, is stored in the chamber 42. The inflator 24 could, however, be an alternative inflator type such as pyrotechnic, augmented, or hybrid.

The structure 40 includes a container portion 50, a fill cap 70, and an outlet assembly 80. The container portion 50 has a generally cylindrical side wall 52 centered on a longitudinal axis 54. The side wall 52 has a first end portion 56 and an opposite end portion 58. As shown in FIGS. 2 and 3, the first and second end portions 56 and 58 of the side wall 52 may be configured to extend in a direction transverse to and toward the axis 54 (i.e., rounded or tapered toward the axis).

The fill cap 70 has a generally cylindrical side wall portion 72 centered on a longitudinal axis 74. The fill cap 70 also includes an end wall portion 76 that spans the open diameter of the side wall portion 72 at an end of the side wall. The fill cap 70 may further include a flange portion 78 that extends from an end of the side wall portion 72 opposite the end wall portion 76 in a direction transverse to and away from the axis 74. The end wall portion 76 includes a fill aperture 82 through which inflation fluid may be directed to fill the chamber 42. A ball stop 84 may be fixed to the end wall portion 76 by means (not shown), such as welding, to block leakage of inflation fluid through the aperture 82 once the chamber 42 is filled.

The outlet assembly 80 includes a base portion 90 and an end cap 170. The base portion 90 has a generally cylindrical side wall 92 centered on a longitudinal axis 94 of the end cap. The end cap 90 also includes an end wall 96 that is centered on the axis 94. The end wall 96 includes a frusto-conical portion 98 and a ring-shaped portion 100, each of which extends transverse to and toward the axis 94. An opening 102 in the end wall 96 extends through the ring-shaped portion 100. As shown in FIG. 2, the outlet assembly 80 includes a rupturable closure member 104, such as a burst disk, that is connected to the ring-shaped portion 100 of the end wall 96 and spans the opening 102. The closure member 104 may be connected to the end wall 96 by known means (not shown), such as welding, an adhesive, a mechanical connection (e.g., press-fit), or a combination thereof.

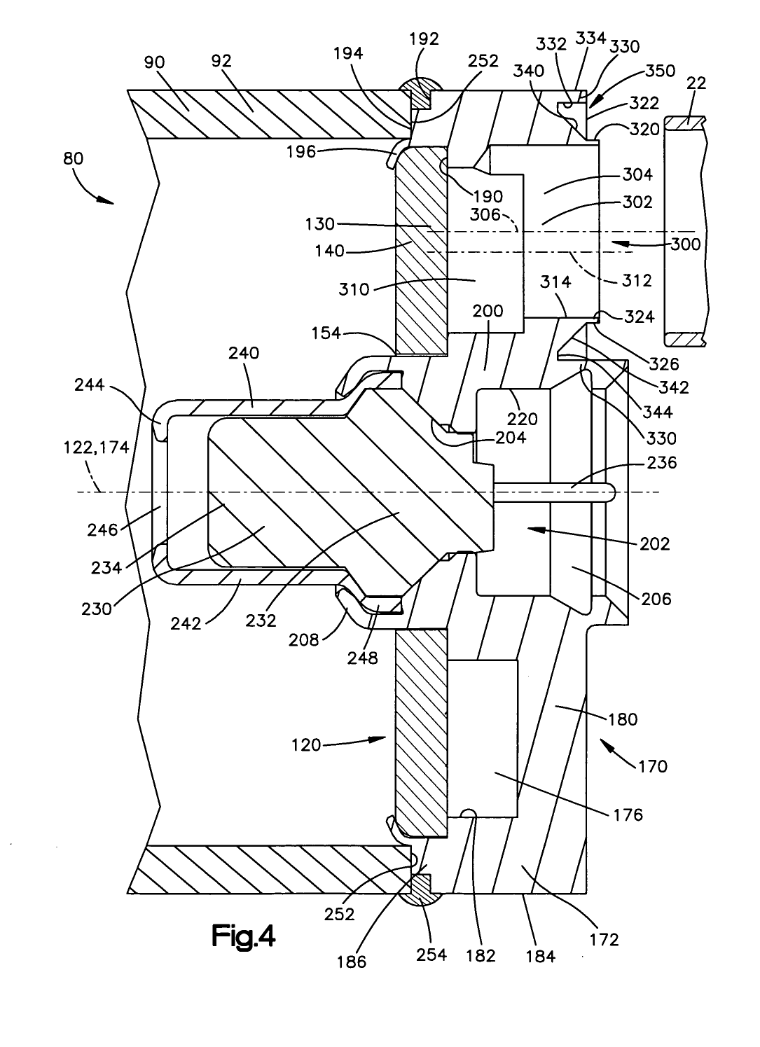

The outlet assembly 80 also includes a filter assembly 120 supported by the end cap 170. Referring to FIGS. 4 and 5, the filter assembly 120 has a generally cylindrical or disk shaped configuration with a central aperture 124 centered on an axis 122. The filter assembly 120 may have a variety of configurations including one or more components. For example, the filter assembly 120 may include a support plate for supporting one or more filter sheets. The support plate may be constructed of a high-strength material, such as steel, and include a plurality of apertures through which inflation fluid may pass. The filter sheets may have a variety of constructions, such as a wire mesh or perforated metal sheet construction.

The end cap 170 includes a generally cylindrical side wall 172 centered on a longitudinal axis 174. The side wall 172 helps define a cavity 176 in the end cap 170. The end cap 170 also includes an end wall 180 that extends transversely from the side wall 172 toward the axis 174 and helps further to define the cavity 176.

The side wall 172 has an inner surface 182 and an opposite outer surface 184. The side wall 172 also has a terminal end portion 186 opposite the end wall 180. Along the end portion 186 of the side wall 172, the inner surface 182 has a diameter that is larger than the diameter of the remainder of the inner surface of the side wall. This forms an annular inner shoulder portion 190 at the end portion 186 of the side wall 172.

Also, along the end portion 186 of the side wall 172, the outer surface 184 has a diameter that is smaller than the diameter of the outer surface of the side wall closest to the end wall 180. This forms an annular first outer shoulder portion 192 of the end portion 186 of the side wall 172. Farther along the end portion 186 of the side wall 172 in a direction away from the end wall 180, the outer surface 184 has a diameter that is further decreased from the diameter of the outer surface of the side wall adjacent the first outer shoulder 192. This forms an annular second outer shoulder portion 194 and an annular rim portion 196 of the end portion 186 of the side wall 172. The rim portion 196 forms a terminal end of the side wall 172.

The end cap 170 includes a central portion 200 centrally located on the end wall 180 and centered on the axis 174. The central portion 200 includes a side wall 220 having several cylindrical and frusto-conical segments of varying diameters. The side wall 220 defines a central passage 202 that extends through the central portion 200. The side wall 220 also defines an initiator receiving portion 204 of the central portion 200 and a connector receiving portion 206 of the central portion. The initiator receiving portion 204 includes an annular rim portion 208 that forms a terminal end of the central portion 200.

The end cap 170 also includes a conduit receiving portion or outlet portion 300 including an outlet passage 302 that extends through the end wall portion 180. The outlet passage 302 has a first portion 304 centered on an axis 306 and a second portion 310 centered on an axis 312 that is offset from and parallel to the axis 306. The axis 306 and the axis 312 are offset from and extend parallel to the axis 174 of the end cap 170. The outlet passage 302 is defined by a side wall 314 that has several cylindrical and frusto-conical segments of varying diameters.

As best shown in FIG. 4, the outlet portion 300 of the end cap 170 includes a cylindrical inner sleeve 320 that projects from an end surface 322 of the end cap 170. The inner sleeve 320 is centered on the axis 306 and has an inner surface 324 that merges with the side wall 314 of the outlet passage 302. The inner sleeve 320 has an outer surface 326 opposite the inner surface 324.

The outlet portion 300 also includes a cylindrical outer side wall 330 centered on the axis 306. The outer side wall 330 encircles the inner, sleeve 320 and the outlet passage 302 and has an inner surface 332 that is spaced apart from and faces the outer surface 326 of the inner sleeve 320. The outer side wall 330 has an outer surface 334 opposite the inner surface 332 that merges with the outer surface 184 of the end cap 170.

The outlet portion 300 further includes an annular end wall 340 that extends from the outer surface 326 of the inner sleeve 320 to the inner surface 332 of the outer side wall 330. The end wall 340 extends transversely of the axis 306 at an acute angle with the axis 306. As shown in FIG. 4, the end wall 340 may include a first portion 342 that extends from the inner sleeve 320 at the acute angle described above and a second portion 344 that extends generally perpendicular to the axis 306 and intersects the outer side wall 330.

The inner sleeve 320, outer side wall 330, and end wall 340 help define an annular conduit receiving space or channel 350 of the outlet portion 300. The annular channel 350 encircles the inner sleeve 320 and the outlet passage 302. The annular channel 350 is centered on the axis 306 and extends into the end surface 322 of the end cap 170.

Referring to FIGS. 4 and 5, the outlet assembly 80 also includes an initiator 230 and a support barrel 240. The initiator 230 may have a variety of known configurations. In the embodiment illustrated in FIGS. 4 and 5, the initiator 230 includes a body portion 232, a cylindrical squib portion 234, and terminals or leads 236 that protrude from the body portion opposite the squib portion. The body portion 232 is formed by several cylindrical and frusto-conical segments of varying diameters.

The support barrel 240 has a generally cylindrical side wall 242 and a terminal end wall 244. The end wall 244 includes a centrally located opening 246. The side wall 242 has a terminal end portion opposite the end wall 244 with an increased diameter that helps define an annular shoulder portion 248 of the support barrel 240.

In an assembled condition of the outlet assembly 80, the initiator 230 and support barrel 240 are assembled with the central portion 200 of the end cap 170. The initiator 230 is inserted in the initiator receiving portion 204 and the terminals 236 extend through the central passage 202 into the connector receiving portion 206. The body portion 232 of the initiator 230 engages and mates with an inner surface of the initiator receiving portion 204.

The support barrel 240 is placed over the initiator 230 such that the shoulder portion 248 engages and mates with the body portion 232 of the initiator. The squib portion 234 may engage and mate with an inner surface of the side wall 242 and is positioned adjacent or near the opening 246 in the end wall 244.

With the initiator 230 and the support barrel 240 positioned in the central portion 200 of the filter retainer 170, the rim portion 208 is crimped (i.e., bent or deformed) onto the shoulder portion 248. The rim portion 208 clamps the support barrel 240 and the initiator 230 to the central portion 200 and thereby connects the initiator and support barrel to the end cap 170.

The filter assembly 120 is also assembled with the end cap 170. The filter assembly 120 is placed in the cavity 176 of the filter retainer such that the assembly is positioned against the inner shoulder portion 190. The central portion 200 of the end cap 170 and the initiator 230 extend through the aperture 124 of the filter assembly 120.

With the filter assembly 120 seated against the inner shoulder portion 190 of the filter retainer 170, the rim portion 196 is deformed onto the filter assembly 120 to connect the filter assembly to the filter retainer 170. The filter assembly 120 is thus clamped between the rim portion 196 and the inner shoulder portion 190 of the filter retainer 170.

In the assembled condition of the outlet assembly 80, the end cap 170 (FIG. 4) is connected with the base portion 90. A terminal end surface 252 of the side wall 92 of the base portion 90 is received on and engages the second outer shoulder portion 194 of the end cap 170. The end cap 170 may then be connected to the base portion 90 by means such as a weld 254. A clearance between the base portion 90 and the filter retainer 170 created by the first outer shoulder portion 192 may facilitate the weld 254. The base portion 90, the end cap 170, filter assembly 120, initiator 230, and support barrel 240 assembled together form the outlet assembly 80 as shown in FIG. 4.

In the assembled condition of the inflator 24 (FIGS. 2 and 3), the outlet assembly 80 is fixed to the first end portion 56 of the container portion 50 by means 270, such as a weld. The fill cap 70 is also connected to the container portion by means 272, such as a weld. The inflator 24, being in the assembled condition of FIGS. 2, 3, and 5, can be connected with the fill tube 22.

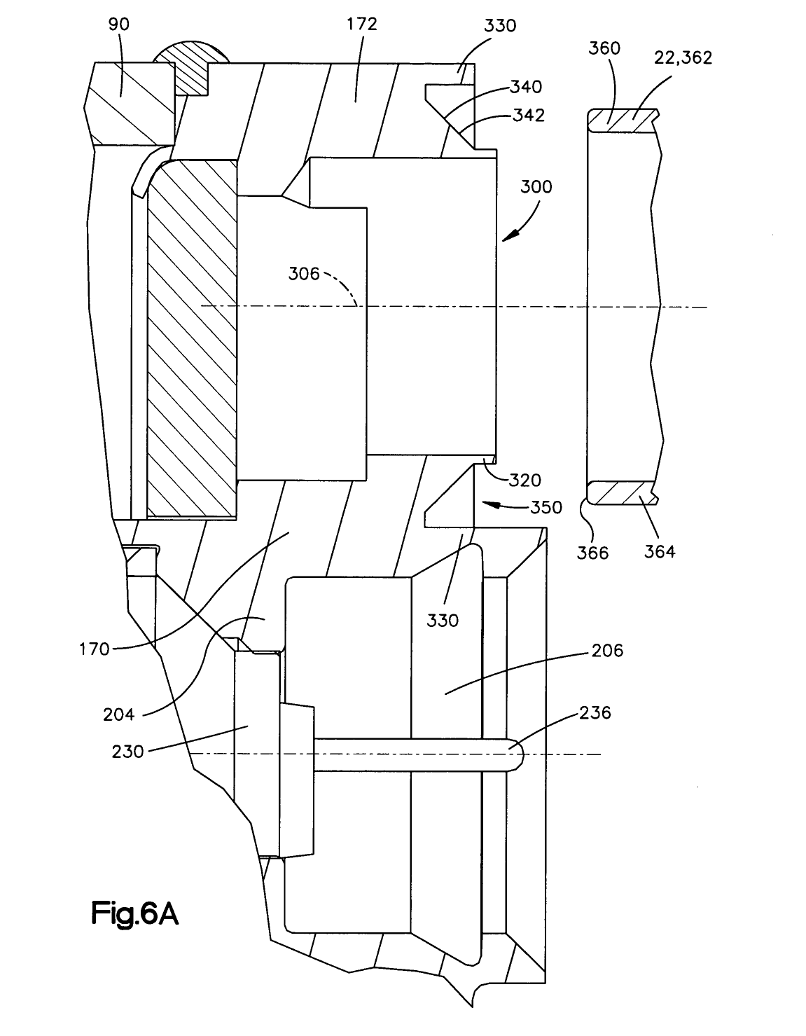

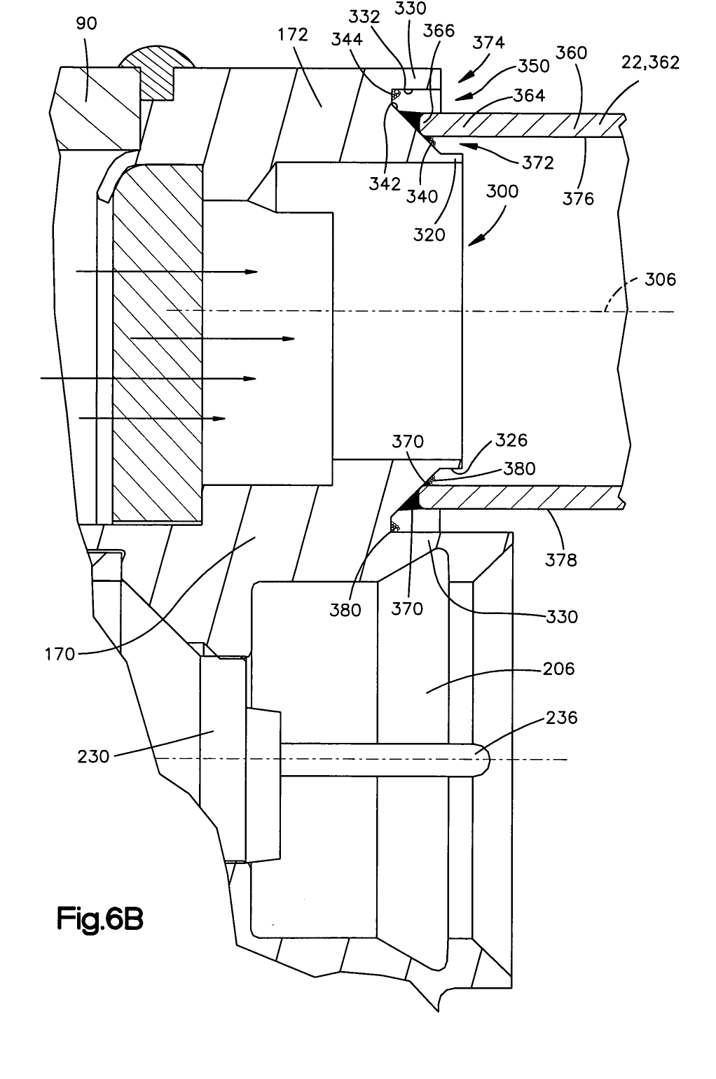

The fill tube may be welded directly to the outlet portion 300 of the end cap 170 or may be connected to the outlet portion the via a connector sleeve welded to the outlet portion. Such a connector sleeve would include means (not shown) positioned opposite the outlet portion 300, such as screw threads or a screw fitting, for connecting the fill tube 22 to the connector sleeve. In FIGS. 6A and 6B, an inflation fluid conduit 360 is illustrated as being connected to the outlet portion 300 of the end cap 170. This inflation fluid conduit may be the fill tube 22 or a connector sleeve 362, as described above.

Referring to FIG. 6A, the conduit 360 is positioned along the axis 306 in alignment with the outlet portion 300. As shown in FIG. 6A, the outside diameter of the conduit 360 is smaller than the inside diameter of the outer side wall 330. Also, the inside diameter of the conduit 360 is larger than the outside diameter of the inner sleeve 320.

As the conduit 360 is moved axially into the channel 350 and into engagement with the outlet portion 300, an end portion 364 of the conduit passes over the inner sleeve 320, as shown in FIG. 6B. A terminal end 366 of the conduit 360 eventually engages the angled first portion 342 of the end wall 340. The angled configuration of the first portion 342 of the end wall 340 may help guide or urge the conduit 360 to the position centered on the axis 306, as shown in FIG. 6B. The conduit 360 is then welded to the end cap 170 via a weld 370 that secures the terminal end 366 of the conduit to the first portion 342 of the end wall 340. The weld 370 may be formed by suitable means, such as resistance welding, e.g., capacitive discharge welding.

The end portion 364 of the conduit 360 divides the annular channel 350 into an inner annular space or channel 372 and an outer annular space or channel 374. The inner annular channel 372 is defined by the outer surface 326 of the inner sleeve 320, an inner surface 376 of the conduit 360, and the first portion 342 of the end wall 340. The outer annular channel 374 is defined by the inner surface 332 of the outer side wall 330, an outer surface 378 of the conduit 360, and the first and second portions 342 and 344 of the end wall 340.

When the end portion 364 of the conduit 360 is welded to the end wall 340, weld spatter 380 may be produced during formation of the weld 370. This weld “spatter” is a byproduct of the welding process and includes metal particles expelled while forming the weld 370 that do not form a part of the weld. The weld spatter 380 can take the form of small beads that tend to stick to the metal parts, e.g., the conduit 360 or end cap 170, adjacent the weld 370.

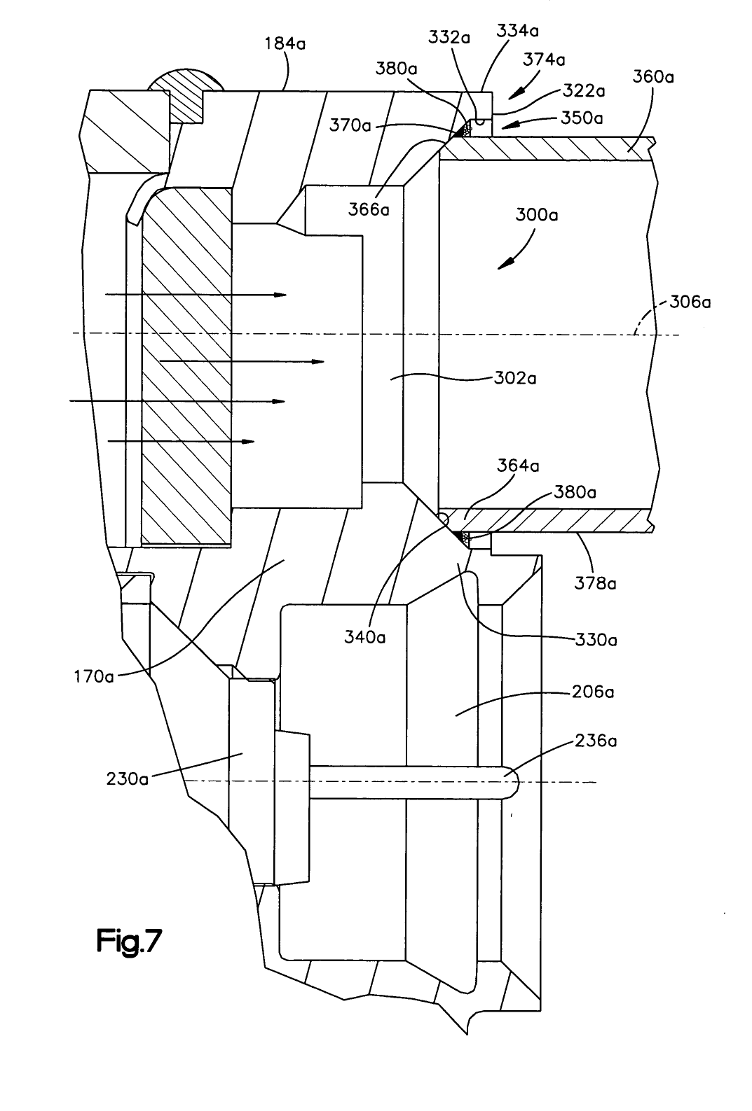

As shown in FIGS. 6A and 6B, the terminal end 366 of the conduit 360 may have a rounded configuration, which may help reduce the formation of the weld spatter 380. In comparison with a terminal end having a squared configuration, the rounded configuration increases the mass of the metal conduit 360 adjacent the weld 370 and thus may promote a more rapid cooling of the weld. The rounded configuration may also help provide a more rapid increase in the contacting surface areas of the conduit 360 and end cap 170 as the metal fuses during the welding operation. Both of these factors may help reduce the amount of weld spatter 380. Those skilled in the art will appreciate that the conduit 360 may have alternative configurations, such as a chamfered configuration (see FIG. 7), for helping to increase the mass of the conduit metal contacting the end cap 170.

When the conduit 360 is welded to the end cap 170, the inner and outer annular channels 372 and 374 serve as receptacles for collecting the weld spatter 380. The inner annular channel 372 helps shield the weld spatter 380 from direct exposure to the flow path of inflation fluid as it exits through the outlet passage 302. This helps minimize contact between the weld spatter and the inflation fluid. This flow path is indicated generally by the arrows in FIG. 6B. This helps prevent the weld spatter 380 from being dislodged by the inflation fluid and carried by the fluid through the conduit 360 and into the inflatable curtain 14. The outer annular channel 374 helps place the weld spatter 380 spaced from the vicinity of the connector receiving portion 206 and thus away from the leads 236 of the initiator 230. This helps prevent the weld spatter 380 from interfering with electrical contacts made with the leads 236.

A second embodiment of the present invention is illustrated in FIG. 7. The second embodiment of the invention is similar to the first embodiment of the invention illustrated in FIGS. 1-6B. Accordingly, numerals similar to those of FIGS. 1-6B will be utilized in FIG. 7 to identify similar components, the suffix letter “a” being associated with the numerals of FIG. 7 to avoid confusion.

In the embodiment illustrated in FIGS. 1-6B, the end cap 170 is configured to form both the inner annular channel 372 and outer annular channel 374 when the conduit 360 is received in the outlet portion 300. Those skilled in the art, however, will appreciate that the end cap 170 may be configured to form the inner annular channel 372 only or the outer annular channel 374 only when the conduit 360 is received in the outlet portion 300. One such configuration, in which the end cap 170 is configured to form the outer channel only, is shown in FIG. 7.

As shown in FIG. 7, the outlet portion 300a of the end cap 170a includes a cylindrical outer side wall 330a centered on the axis 306a. The outer side wall 330a encircles the outlet passage 302a and has an inner surface 332a. The outer side wall 330a has an outer surface 334a opposite the inner surface 332a that merges with the outer surface 184a of the end cap 170a.

The end wall 340a extends from the inner surface 332a of the outer side wall 330a to the outlet passage 302a. The end wall 340a extends transversely of the axis 306a at an acute angle with the axis 306a. The outer side wall 330a and end wall 340a help define an annular conduit receiving space or channel 350a of the outlet portion 300a. The annular channel 350a encircles the outlet passage 302a. The annular channel 350a is centered on the axis 306a and extends into the end surface 322a of the end cap 170a.

As shown in FIG. 7, the terminal end 366a of the conduit 360a may have a chamfered configuration, which may help reduce the formation of the weld spatter 380a. In comparison with a terminal end having a squared configuration, the chamfered configuration increases the mass of the metal conduit 360a adjacent the weld 370a and thus may promote a more rapid cooling of the weld. The chamfered configuration may also help provide a more rapid increase in the contacting surface areas of the conduit 360a and end cap 170a as the metal fuses during the welding operation. Both of these factors may help reduce the amount of weld spatter 380a. Those skilled in the art will appreciate that the conduit 360a may have alternative configurations, such as the rounded configuration of FIGS. 1-6B, for helping to increase the mass of the conduit metal contacting the end cap 170a.

As the conduit 360a is moved into engagement with the outlet portion 300a, the chamfered terminal end 366a of the conduit 360a eventually engages the angled end wall 340a. The angle of the chamfered terminal end 366a with respect to the axis 306a may be the same or substantially the same as the angle of the end wall 340a with respect to the axis 306a. The chamfered terminal end 366a may thus extend parallel to the end wall 340a and provide a mating engagement with the end wall. This may help guide or urge the conduit 360a to the position centered on the axis 306a, as shown in FIG. 7. The conduit 360a is then welded to the end cap 170a via the weld 370a, which that secures the terminal end 366a of the conduit to the end wall 340a. The weld 370a may be formed by suitable means, such as resistance welding, e.g., capacitive discharge welding.

The end portion 364a of the conduit 360a helps form an outer annular space or channel 374a. The outer annular channel 374a is defined by the inner surface 332a of the outer side wall 330a, an outer surface 378a of the conduit 360a, and the end wall 340a. When the conduit 360a is welded to the end cap 170a, the outer annular channel 374a serves as a receptacle for collecting the weld spatter 380a. The outer annular channel 374a helps place the weld spatter 380a spaced from the vicinity of the connector receiving portion 206a and thus away from the leads 236a of the initiator 230a. This helps prevent the weld spatter 380a from interfering with electrical contacts made with the leads 236a.

From the above description of the invention, those skilled in the art will perceive improvements, changes and modifications. For example, although the illustrated embodiments have been shown and described as having an overall generally cylindrical configuration with generally circular cross-sections, alternative configurations, such as ones having rectangular or polygonal cross-sections, may also be implemented and incorporate the features of the present invention described above. Thus, for example, use herein of the word “annular” is meant to describe a generally circular or cylindrical ring-shaped geometry in reference to the generally cylindrical configurations of the illustrated embodiment. In the alternative configurations, such as the rectangular or polygonal configurations described above, “annular” is meant to describe the corresponding ring-shaped geometry resulting from the alternative configurations.

As another example, although the illustrated embodiment has been described as being used in conjunction with an inflatable curtain, the configuration of the inner and outer annular channels may be applied to inflation fluid sources for other inflatable vehicle occupant protection devices, such as driver side or passenger side air bags, side impact air bags, and inflatable knee bolsters. These and other such improvements, changes and modifications within the skill of the art are intended to be covered by the appended claims.

1. An apparatus for helping to protect an occupant of a vehicle, said apparatus comprising:
an inflatable vehicle occupant protection device;
an inflator for providing inflation fluid for inflating said inflatable vehicle occupant protection device; and
a conduit for delivering the inflation fluid from said inflator to said inflatable vehicle occupant protection device;
said inflator comprising an outlet passage and a conduit receiving portion for receiving an end portion of said conduit, said conduit receiving portion including a wall portion that encircles said outlet passage and is spaced from said end portion of said conduit to help define a annular space between said wall portion and said end portion.

2. The apparatus recited in claim 1, wherein said conduit receiving portion further comprises an end wall that extends from said wall portion toward said conduit, said end wall helping to define said annular space.

3. The apparatus recited in claim 2, further comprising a weld connecting said end portion of said conduit to said end wall of said conduit receiving portion.

4. The apparatus recited in claim 3, wherein said annular space serves as a receptacle for collecting weld spatter generated during the formation of said weld.

5. The apparatus recited in claim 2, wherein said end wall of said conduit receiving portion extends at an acute angle relative to an axis of said conduit receiving portion.

6. The apparatus recited in claim 5, wherein said end portion of said conduit has a rounded terminal end that cooperates with said end wall of said conduit receiving portion to align said end portion of said conduit coaxially with said conduit receiving portion.

7. The apparatus recited in claim 1, wherein said wall portion and said end portion of said conduit are arranged coaxially with each other.

8. The apparatus recited in claim 1, wherein said wall portion of said conduit receiving portion comprises an outer side wall, said end portion of said conduit being extendable into a space bounded by said outer side wall, an inner surface of said outer side wall and an outer surface of said conduit being spaced apart from each other to help define said annular space between said conduit and said outer side wall.

9. The apparatus recited in claim 8, wherein said conduit receiving portion further comprises an inner sleeve extendable into said end portion of said conduit when said conduit is received in said conduit receiving portion, a second annular space being defined between an outer surface of said inner sleeve and an inner surface of said end portion of said conduit.

10. The apparatus recited in claim 9, wherein said inner sleeve has an inner surface that merges with a surface defining said outlet passage of said inflator.

11. The apparatus recited in claim 10, wherein said conduit receiving portion further comprises an end wall that extends from said inner surface of said outer side wall to said outer surface of said inner sleeve, said inner sleeve, said outer side wall and said end wall defining said conduit receiving portion.

12. The apparatus recited in claim 11, wherein said conduit when received in said conduit receiving portion divides said conduit receiving portion annular space into said annular space and said second annular space.

13. The apparatus recited in claim 1, wherein said wall portion comprises an inner sleeve extendable into said end portion of said conduit when said conduit is received in said conduit receiving portion, said annular space being defined between an outer surface of said inner sleeve and an inner surface of said end portion of said conduit.

14. The apparatus recited in claim 13, wherein said conduit receiving portion further comprises an outer side wall, said end portion of said conduit being extendable into a space bounded by said outer side wall, a second annular space being defined between an outer surface of said end portion of said conduit and an inner surface outer side wall.

15. The apparatus recited in claim 14, wherein said conduit receiving portion further comprises an end wall that extends from said inner surface of said outer side wall toward said outer surface of said inner sleeve, said inner sleeve, said outer side wall and said end wall defining said conduit receiving portion.

16. The apparatus recited in claim 15, wherein said conduit when received in said conduit receiving portion divides said conduit receiving portion annular space into said annular space and said second annular space.

17. The apparatus recited in claim 1, wherein said inflator further comprises:
a structure defining a chamber for storing inflation fluid under pressure;
a closure member rupturable to release said inflation fluid from said chamber into said outlet passage; and
an initiator actuatable to rupture said closure member.

18. The apparatus recited in claim 17, wherein said structure defining said chamber comprises a generally cylindrical container and end cap centered on a longitudinal axis of said inflator, said end cap comprising said conduit receiving portion.

19. The apparatus recited in claim 1, wherein said inflatable vehicle occupant protection device comprises an inflatable curtain inflatable between a side structure of the vehicle and a vehicle occupant.

20. The apparatus recited in claim 1, wherein said conduit comprises a connector sleeve connectable with a conduit for delivering said inflation fluid to the inflatable vehicle occupant protection device.

21. The apparatus recited in claim 1, wherein said conduit comprises a conduit for delivering said inflation fluid to the inflatable vehicle occupant protection device.

22. An apparatus for providing inflation fluid to an inflatable vehicle occupant protection device, said apparatus comprising:
an inflator actuatable to provide inflation fluid for inflating the inflatable vehicle occupant protection device, said inflator including an outlet passage for discharging inflation fluid from said inflator;
a conduit having an end portion welded to said inflator, said end portion encircling said outlet passage;
an inner channel formed inside said conduit adjacent said end portion of said conduit, said inner channel encircling said outlet passage.

23. The apparatus recited in claim 22, wherein said inner channel comprises:
an inner side wall encircling said outlet passage;
an outer side wall encircling said outlet passage and spaced from said inner side wall; and
an end wall extending from said inner side wall to said outer side wall.

24. The apparatus recited in claim 22, further comprising an outer channel formed outside said conduit adjacent said end portion of said conduit, said outer channel encircling said outlet passage.

25. The apparatus recited in claim 24, wherein said outer channel comprises:
an inner side wall extending about a periphery of said conduit;
an outer side wall encircling said end portion of said conduit; and
an end wall extending from said inner side wall to said outer side wall.

26. An apparatus for providing inflation fluid to an inflatable vehicle occupant protection device, said apparatus comprising:
an inflator actuatable to provide inflation fluid for inflating the inflatable vehicle occupant protection device, said inflator including an outlet passage for discharging inflation fluid from said inflator;
a conduit having an end portion welded to said inflator, said end portion encircling said outlet passage;
an outer channel formed outside said conduit adjacent said end portion of said conduit, said outer channel encircling said outlet passage.

27. The apparatus recited in claim 26, wherein said outer channel comprises:
an inner side wall extending about a periphery of said conduit;
an outer side wall encircling said end portion of said conduit; and
an end wall extending from said inner side wall to said outer side wall.

28. The apparatus recited in claim 26, further comprising an inner channel formed inside said conduit adjacent said end portion of said conduit, said inner channel encircling said outlet passage.

29. The apparatus recited in claim 28, wherein said inner channel comprises:
an inner side wall encircling said outlet passage;
an outer side wall encircling said outlet passage and spaced from said inner side wall; and
an end wall extending from said inner side wall to said outer side wall.

30. An apparatus comprising:
an inflator actuatable to provide inflation fluid for inflating an inflatable vehicle occupant protection device;
a conduit for delivering inflation fluid to the inflatable vehicle occupant protection device;
a weld for securing said conduit to said inflator; and
means for collecting weld spatter generated during the formation of said weld.

31. The apparatus recited in claim 30, wherein said means for collecting weld spatter comprises an inner annular channel for collecting weld spatter inside said conduit.

32. The apparatus recited in claim 30, wherein said means for collecting weld spatter comprises an outer annular channel for collecting weld spatter outside said conduit.

33. The apparatus recited in claim 30, wherein said means for collecting comprises an annular channel for receiving a terminal end portion of said conduit, said terminal end portion dividing said annular channel into an inner annular channel for collecting weld spatter inside said conduit and an outer annular channel for collecting weld spatter outside said conduit.

34. An inflator for providing inflation fluid to an inflatable vehicle occupant protection device via a conduit, said inflator comprising:
a structure defining a chamber for storing inflation fluid under pressure;
a closure member rupturable to release said inflation fluid from said chamber; and
an end cap connectable with said structure, said end cap being connectable with the conduit via a weld, said end cap including an annular channel located inside the conduit for collecting weld spatter resulting from the weld.

35. An inflator for providing inflation fluid to an inflatable vehicle occupant protection device via a conduit, said inflator comprising:
a structure defining a chamber for storing inflation fluid under pressure;
a closure member rupturable to release said inflation fluid from said chamber; and
an end cap connectable with said structure, said end cap being connectable with the conduit via a weld, said end cap including an annular channel located outside the conduit for collecting weld spatter resulting from the weld.
